(19) United States
(12) Patent Application Publication
(10) Pub. No.: US 2002/0135118 A1
(43) Pub. Date: Sep. 26, 2002

(54) Windshield Holder

(76) Inventor: Hsin-FA Kang, Tainan City (TW)

Correspondence Address: Hsin -Fa Kang, P.O. Box 90, Tainan City, 704, TW

(21) Appl. No.: 09/813,841

(22) Filed: Mar. 22, 2001

(51) Int. Cl. B23Q 3/00

(52) U.S. Cl. 269/296

(57) ABSTRACT

A windshield holder includes a foot frame, two connect frames, a lateral rod, and plural support members combined together. The foot frame has two detachable support rods at both sides. Each connect frame has an inverted U-shaped connect rod connected to the fit end of each support rod. A connect chain is provided between two inverted U-shaped connect rods, and plural protruding tubes are fixed on each connect rod for receiving rubber support members, The windshield holder is not only easy and quick in assembling or disassembling, but also decreases dimensions and lowers cost of transporting.

### BACKGROUND OF THE INVENTION

1. Field of the Invention

This invention relates to a windshield holder consisting of a foot frame, two connect frames and plural support members as main components combined together.

The foot frame has two detachable support rods pivotally positioned at both sides, and the two connect frames respectively have an inverted U-shaped connect rod fitted correspondingly in a fit end of each support rod.

Then, a connect chain with its length adjustable is provided between the two connect rods, and plural rubber supports are fitted in relative short tubes on the connect rod. The windshield holder is not only easy and quick in assembling or disassembling, but also convenient in storing and possible to lower cost of transporting due to its reduced dimensions.

2. Description of the Prior Art

Generally, after a windshield is formed in shape, its edges have to be trimmed smooth before providing protective bars around for fitting on an automobile. To do the trimming, a windshield is placed on a holder, with its edges suspending without support, as shown in FIG. 6. And in order to prevent the surface of a windshield to be trimmed from damaging, some rubber cushions 40 are provided spaced apart on an upper portion of the support frame 4 for fixing and protecting it during trimming.

However, the frame body of a known conventional windshield holder in formed in a fixed style, and is bulky in dimensions, inconvenient for transporting, requiring a large space for storing and increasing cost of transporting.

### SUMMARY OF THE INVENTION

The objective of the invention is to offer a windshield holder having an effectiveness of easiness and quickness in assembling or disassembling, reducing dimension, facilitating transporting and lowering cost of transporting.

The feature of the invention is a foot frame having two detachable support rods pivotally provided at both sides. Each support rod has a fit end on top, and two connect frames respectively engaged on each support rod of the foot frame, and a lateral rod provided between two support rods with relative ends fitting with the fit ends of the two support rods, then plural protruding tubes formed spaced apart protruding up from the connect frame and plural rubber supports engaged with the protruding tubes of each connect rod of the connect frame.

### BRIEF DESCRIPTION OF DRAWINGS

This invention will be better understood by referring to the accompanying drawings wherein:

FIG. 1 is an exploded perspective view of a windshield holder in the present invention;

FIG. 2 is a perspective view of the windshield holder in the present invention;

FIG. 3 is a magnified side cross-sectional view of a support rod combined with a connect rod in the present invention;

FIG. 4 is a perspective view of two connect rods with their distance adjusted by a connect chain in the present invention;

FIG. 5 is a perspective view of the windshield holder in using process in the present invention; and,

FIG. 6 is a perspective view of a known conventional windshield holder.

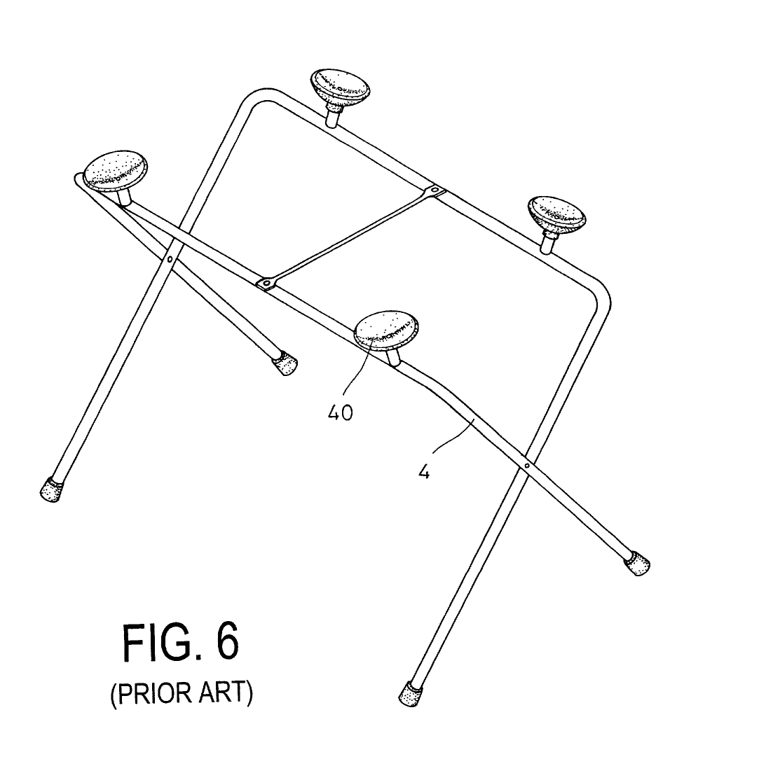

### DETAILED DESCRIPTION OF THE PREFERRED EMBODIMENT

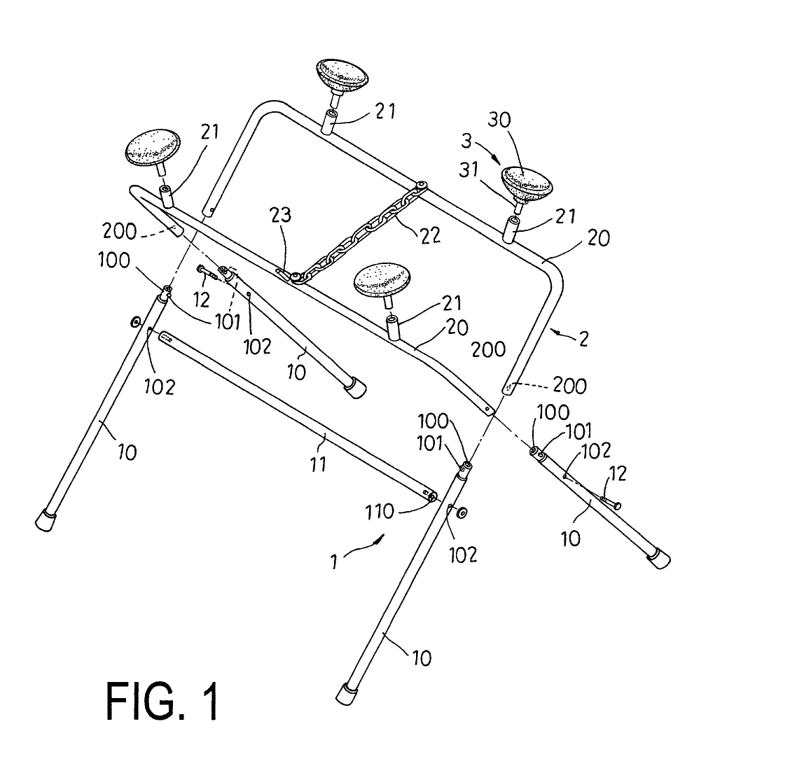

A preferred embodiment of a windshield holder in the present invention, as shown in FIG. 1, includes a foot frame 1, a lateral rod 11, two connect frames 2 and plural support members 3 as main components combined together.

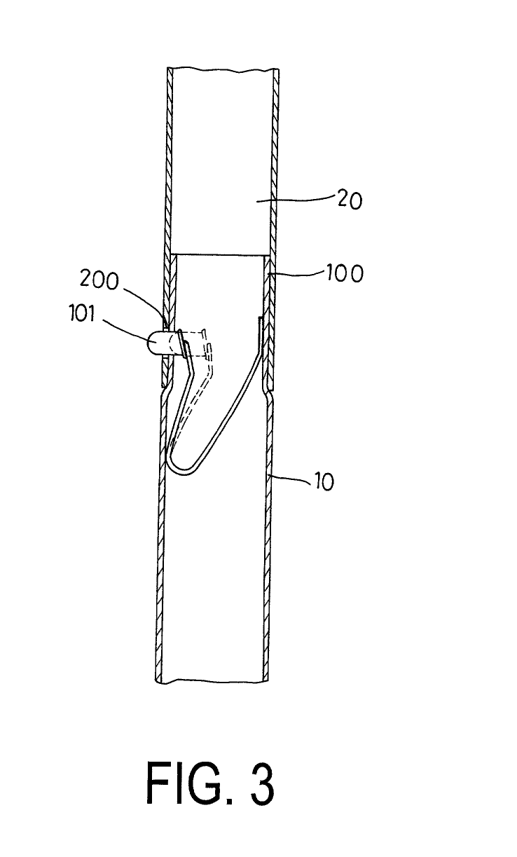

The foot frame 1 has two vertical tubular support rods 10 connected by the lateral rod 11. The upper end of each support rod 10 is formed as a fit end 100 with a comparatively small diameter, and each fit end 100 has an elastically retractable fit lug 101 protruding out from an outer wall, as shown in FIG. 3, and further, a through hole 102 is bored in a proper position near a lower portion of the fit end 100.

The lateral rod 11 has a pivotal end 110 with female threads at each end, and is fixedly connected with two support rods 10 by means of a pivot 12 with male threads passing through the through hole 102 of the support rod 10 and connecting with the pivotal end 110 of the lateral rod 11.

The connect frames 2 are composed of two inverted U-shaped connect rods 20 to be correspondingly combined with the support rods 10 of the foot frame 1, and each connect rod 20 has slots 200 oppositely provided in the tubular wall of each rod end to engage with the lug 101 of the support rod 10.

Besides, the connect rods 20 have short protruding tubes 21 protruding upward and slanting a little outward at proper positions near two ends, and a connect chain 22 adjustable in its position provided between the two connect rods 20, and then, a position stud 23 for positioning the connect chain 22 is disposed on a center portion of one connect rod 20.

In addition, plural support members 3 are fitted in the protruding tube 21 of the connect frame 2, respectively having a support surface 30 on top shaped like a round sucking plate and a bottom projection 31 protruding out to engage a relative protruding tube 21. The support members 3 are made of rubber able to keep a windshield in place stably.

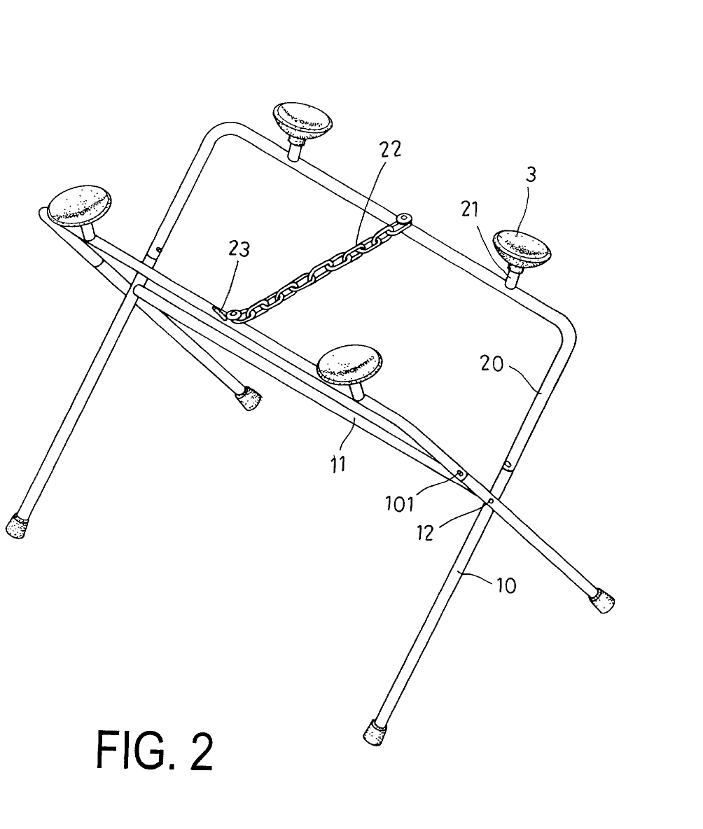

In assembling, referring to FIGS. 1, 2 and 3, firstly cross two side support rods 10 of the foot frame 1, aligning the through holes 102 exactly facing each other and also facing the pivotal end 1 10 of the lateral rod 11 at the same time, and then insert a screw 12 through the two through holes 102 and pivotally connected with the pivotal end 11 of the lateral rod 11. Next, correspondingly fit two ends of each connect rod 20 of the connect frame 2 with two fit ends 100 of the support rods 10 of the foot frame 1, letting the lug 101 of the fit portion 100 engaging with the slot 200 of the connect rod 20 and press the elastic lug 101 sliding to the slot 200, to protrude thereout to be stabilized. Thus the connect rods 20 and the support rods 10 are combined stably. Lastly, engage the bottom projections 31 of the rubber support members 3 into the protruding tubes 21 of the connect frame 2, finishing combination of a windshield holder, as shown in FIG. 2.

On the contrary, in disassembling, just press the elastic lug 101 of the support rod 10 shrink inward, as shown in FIG. 3, and then pull up the connect rod 20, easily separating it from the support rod 10 to reduce the dimensions for storing.

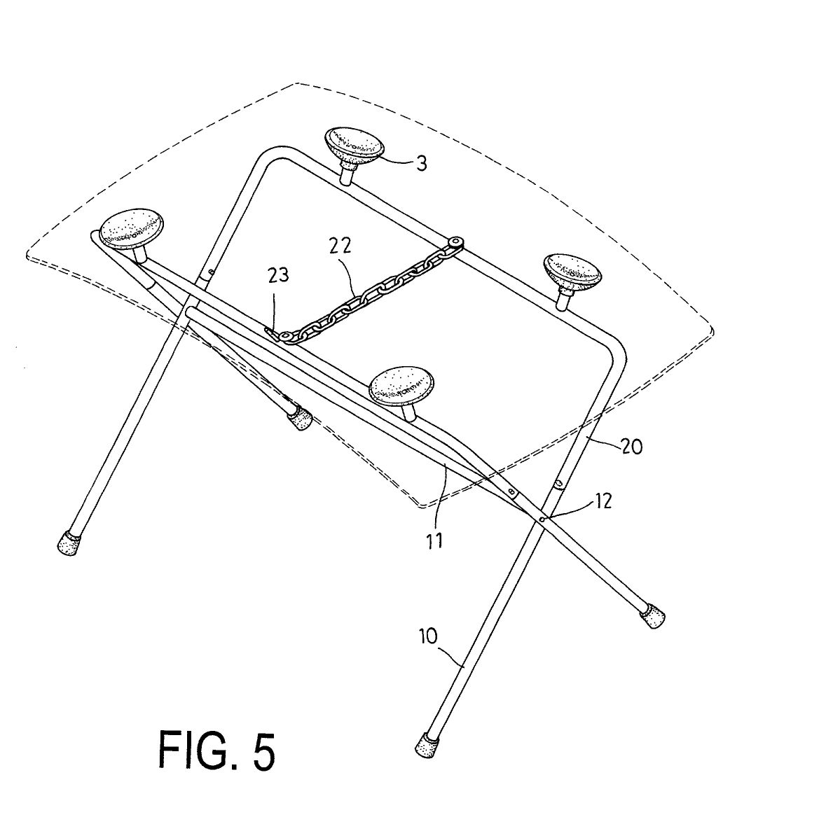

In using and handling, just push outward two connect rods 20 of the connect frame 2 to let the support rods 10 of the foot frames 1 move out oppositely in an intersection shape by help of a shaft formed at a pivotal joint of the support rods 10 and the lateral rod 11, and at the same time, two connect rods 20 of the connect frames 2 naturally stretch toward opposite sides; next a windshield formed in shape with its edges not yet trimmed is placed on the support members 3, as shown in FIG. 5, and kept in place by means of the support surfaces 30 of the support members 3, facilitating trimming of the windshield.

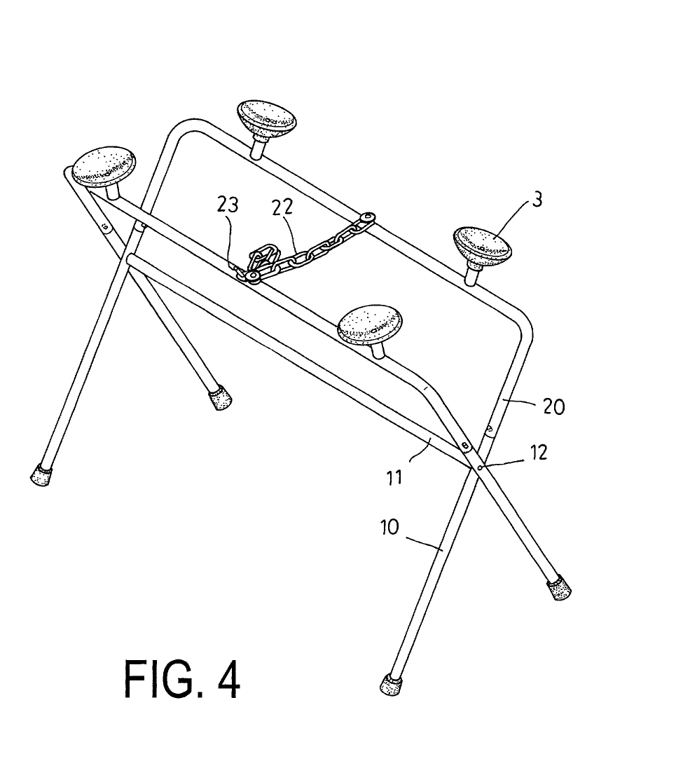

Furthermore, the connect chain 22 matching the position stud 23 can adjust the distance between the two connect rods 20, as shown in FIG. 4, and an assembling angle of the support member 3, can also be adjusted due to its flexibility, thus resulting in much easiness in handling.

As can be understood from the above description, this invention has the following advantages:

1. It is quick and convenient to assemble.

2. It has an effectiveness of easiness in assembling or disassembling, reducing dimensions and convenient in packaging, storing and transporting.

3. It economizes the space needed for storing in a warehouse, largely lowering cost of transporting.

4. The lateral rod pivotally provided between the two support rods of the foot frame strengthens stability of the structure.

5. The mutual engagement of the elastic lug of the fit portion of support rod and the slot of the connect rod ensures stable combination of the connect rod and the support rod, not easy to fall off.

6. The distance between two connect rods and the height of the foot frames can be adjusted at the same time by means of the connect chain, forming practicability of the holder.

While the preferred embodiment of the invention has been described above, it will be recognized and understood that various modifications may be made therein and the appended claims are intended to cover all such modifications that may fall within the spirit and scope of the invention.

What is claimed is:

1. A windshield holder comprising:
a foot frame having two support rods pivotally positioned at opposite side and each said support rod having a fit end on top;
two connect frames assembled on said foot frame, having respectively an inverted U-shaped connect rod provided with two lower ends fitted firmly with said fit ends of said support rods, plural protruding tubes fixed on each said connect rod;
plural support members fitted in said protruding tubes, and made of rubber; and,
said windshield placed on said windshield holder for trimming, said windshield holder being easy in assembling or disassembling, possible to reduce dimensions and lower cost of transporting.

2. The windshield holder as claimed in claim 1, wherein a lateral rod is provided between said two support rods at both sides of said foot frame, and said lateral rod has a pivotal end with female threads, and further each said support rod has a through hole corresponding to said female-threaded pivotal end of said lateral rod for a screw to screw therein.

3. The windshield holder as claimed in claim 1, wherein an elastic and retractable lug is disposed on an upper portion of each said support rod for engaging relative insert hole of said connect rod of said connect frame.

4. The windshield holder as claimed in claim 1, wherein a connect chain is provided between said two connect rods of said connect frames, and the length of said connect chain adjustable to control the distance between two said connect rods by matching a position stud fixed on a center portion of one of said connect rods.
